(19) United States
(12) Patent Application Publication
(10) Pub. No.: US 2026/0366339 A1
(43) Pub. Date: Nov. 19, 2026

(54) BICYCLE LOCK SECURING CABLE

(71) Applicant: ABUS August Bremicker Sohne KG, Wetter-Volmarstein (DE)

(72) Inventor: Ernst Pankratius, Wetter (DE)

(21) Appl. No.: 19/677,007

(22) Filed: May 14, 2026

(30) Foreign Application Priority Data
May 16, 2025 (DE) 10 2025 119 065.8

(51) Int. Cl. E05B 71/00; D07B 1/00; D07B 1/16

(52) U.S. Cl. CPC E05B 71/00; D07B 1/005; D07B 1/16; D07B 2201/2009; D07B 2201/20903; D07B 2205/201; D07B 2205/2046

(57) ABSTRACT

A bicycle lock securing cable for securing a bicycle, comprises a flexible cable section extending from a first end to a second end; a first securing device at the first end of the cable section; and a second securing device at the second end of the cable section. The first securing device and the second securing device are configured to selectively hold the cable section in a closed loop. The cable section comprises at least one metal chain; a plurality of securing strands distributed along a circumference of the chain and separate from one another; and a sheath that circumferentially surrounds the chain and the plurality of securing strands. The securing strands comprise different materials, at least one of which is not metal.

### CROSS-REFERENCE TO RELATED APPLICATIONS

The present application claims priority to German Patent Application No. DE 10 2025 119 065.8, filed May 16, 2025, the entire content of which is hereby incorporated by reference in its entirety.

### FIELD

The invention relates to a bicycle lock securing cable for securing a bicycle, comprising a flexible cable section extending from a first end to a second end; a first securing device at the first end of the cable section; and a second securing device at the second end of the cable section; wherein the first securing device and the second securing device are configured to selectively hold the cable section in a closed loop.

### BACKGROUND

Such a bicycle lock securing cable serves as theft protection for a bicycle (for example, a muscle-powered bicycle or an electrically assisted or powered pedelec). By means of the securing cable, the bicycle may be locked to itself (for example, by blocking a wheel) and/or secured to a stationary object (for example, a lamppost or building wall), and/or a part of the bicycle may be secured against theft (e.g., one of the wheels). For this purpose, the cable section may be used to form a circumferentially closed loop that wraps around a part of the bicycle and/or the stationary object. The first securing device and the second securing device at the two ends of the cable section may serve to keep the formed loop in the closed state, in particular by securing the first end and the second end of the cable section to one another, or by having the first end or the second end of the cable section hold a region of the cable section located between the first and second ends (movably or immovably, for example by using an eyelet or a locking mechanism).

For example, the first securing device may comprise a locking mechanism, and the second securing device may comprise a counterpart that can be locked to the locking mechanism so as to form and secure the closed loop. The locking mechanism may, in particular, comprise a key-operated lock cylinder, an electrically driven latch, or a combination lock mechanism, wherein the counterpart may, in particular, comprise a locking bolt or a latch receptacle, as is known, for example, from DE 4434585 A1, U.S. Pat. No. 8,151,604 B2, or DE 8617170 U1. In other embodiments of such a bicycle lock securing cable, the first securing device may in particular comprise an eyelet, wherein the second securing device may be passed through the eyelet to form the closed loop and hold it in the closed state. In such embodiments, the second securing device may in particular comprise a further eyelet, as is known, for example, from WO 02/102649 A1; or a locking bolt, in particular a locking bolt for a frame lock, as is known, for example, from EP 1548216 A2, or a locking bolt for a stationary lock, as is known, for example, from FR 2879555 A1; or a locking mechanism, in particular for a lock on the bicycle, as is known, for example, from EP 0774404 A1, or for a lock at the cable section itself, as is known, for example, from U.S. Pat. No. 6,430,973 B1.

Such a bicycle lock securing cable should, on the one hand, provide the most effective theft protection possible and, on the other hand, be easy to handle and be lightweight so that it may be carried along as effortlessly as possible while riding the bicycle.

### SUMMARY

It is the object of the present invention to provide a bicycle lock securing cable that offers effective theft protection and allows easy use.

This object is achieved by a bicycle lock securing cable comprising the features of Claim 1.

With the bicycle lock securing cable, the flexible cable section forms an elongated securing body which, as explained above, may be looped around a part of a bicycle and/or a stationary object to form a closed loop. The first securing device and the second securing device at the two ends of the cable section are configured to selectively hold the cable section with the formed closed loop, in particular with a fixed or variable length of loop. The cable section comprises at least: a chain, a plurality of securing strands, and a sheath. The securing strands are configured separately from one another and are arranged distributed along a circumference of the chain. The chain is formed of metal. The securing strands comprise different materials, at least one of which is not metal. The sheath surrounds the chain and the plurality of securing strands circumferentially.

Thus, the cable section is configured as a multi-component body that, in addition to a chain, has at least two securing strands comprising of different materials. This means that the at least two securing strands may be formed, relative to each other, of different materials, or that each of the at least two securing strands may comprise the different materials. These different materials may exhibit different properties with respect to their strength, hardness, and/or heat resistance. Said strength may include, in particular, tensile, compressive, and/or flexural strength. Said hardness may, for example, be defined by the Rockwell hardness or Vickers hardness. The different materials may, for example, comprise different types of synthetics, or a metal and at least one synthetic. However, at least one of the materials of the plurality of securing strands does not comprise metal. As a result, material diversity is given, since at least the chain is formed from metal (in particular steel).

The chain, the plurality of securing strands, and the sheath may, in particular, extend continuously between the first end and the second end of the cable section. The securing strands, which are separate from one another, may run substantially next to each other and/or alongside the chain, in particular parallel to the chain or, for example, twisted around the chain. The sheath encloses the arrangement formed by the chain and the securing strands. The sheath may, in particular, be a textile sheet material, for example a fabric or weave made of synthetic fibers. In addition to the chain and said plurality of securing strands, the cable section within the sheath may also include further components, in particular further securing strands of a different type.

The bicycle lock securing cable offers increased protection against forcibly cutting through with a tool. By using a chain in combination with a plurality of other types and materials of securing strands, different types of resistivity are formed, which must be overcome using different kinds of attacking tools. As a result, a significant amount of time is required to forcibly cut through the cable section, which serves as an effective deterrent for bicycle thieves. For example, while a sufficiently strong bolt cutter may cut through a chain, a bolt cutter has relatively blunt blades and therefore it cannot also penetrate thin fibers. Cutting tools with a particular grind are necessary for cutting through rigid plastic fibers. On the other hand, different types of tools are required, for example, to cut through metal wires. Moreover, before the chain and the securing strands are accessible, the sheath of the cable section must first be ripped open.

Notwithstanding the effective theft protection, the cable section of the bicycle lock's securing cable may be configured to be very flexible (in terms of bending), resulting in comfortable handling. Since the securing strands, which exist in addition to the chain, are formed separately from one another and are arranged circumferentially distributed, the chain may, when bent, move into a space between two of the plurality of securing strands within the sheath. The individual securing strands may also be formed to be flexible, in particular, if they are made of a synthetic material. Since the cable section comprises a plurality of components that help with theft protection, the chain may be configured to be smaller and lighter compared to a conventional bicycle lock chain, so that the cable section as a whole may have a relatively low weight. The securing strands surrounding the chain circumferentially may also, in particular if they are made of a synthetic material, provide shock and noise absorption while riding the bicycle, thereby preventing damage caused by the carried along bicycle lock (such as to the bicycle frame) and also no annoying rattling noises from the chain are to be heard.

The terms “securing cable” and “cable section” are to be understood broadly in the context of the invention with regard to the composition of the bicycle lock securing cable according to the invention (which, in particular, also includes a chain).

Within the context of the invention, the term “strand” generally refers to a cohesive, flexible, elongated structure comprising a plurality of fibers (in particular synthetic fibers), yarns, tapes, metal strands, or wires that run parallel to one another—in particular, pressed, fused, or bonded together- or intertwined with one another—for example, braided or twisted. The structure may be made of plastic or metal or a combination thereof. A yarn may in turn be formed from a plurality of fibers. A (metal) strand may be formed from a plurality of wires.

Further embodiments are described below.

In some embodiments, the plurality of securing strands are held by the sheath in a tight configuration around the chain, whereby the plurality of securing strands are supported within the sheath so as to be movable relative to one another. In that the sheath tightly encloses the plurality of securing strands and thereby holds them close together, the elongated cable section has a small diameter and may be easily grasped and held by the user. The securing strands enclosed by the sheath may lie against the chain so as to achieve said absorbing effect and to maintain the stable form of the chain within the formed configuration. However, if an attempt is made to forcibly cut through the cable section, causing the sheath to split and thereby exposing the plurality of securing strands, the plurality of securing strands and the chain are able to move relative to one another, whereby applying and engaging a cutting tool is made significantly more difficult.

According to a preferred embodiment, at least one of the plurality of securing strands comprises a synthetic cable having a plurality of synthetic fibers, wherein at least one further one of the plurality of securing strands comprises a metal cable having a plurality of metal wires and may in particular be formed by a steel cable. As a result, a particularly simple construction of the cable section having effective theft protection is provided. Due to the presence of multiple, in particular a plurality of synthetic fibers, to forcibly cut through the cable section not only requires a (coarse) pinching tool for the chain but also a cutting tool with a suitable (fine) cutting edge. Furthermore, due to the presence of a metal cable, a specialized cutting tool for the individual metal wires must also be used. Applying these various tools is made even more difficult by the surrounding sheath. This combination of obstacles and materials makes any attempt at forcibly cutting through the securing cable both material-intensive and time-consuming.

Said synthetic cable may be a cohesive, flexible, elongated structure consisting of a plurality of synthetic fibers that are braided or twisted together. The synthetic fibers may, for example, consist of polyester. Said metal cable may be a cohesive, flexible, elongated structure consisting of a plurality of metal wires arranged parallel to one another, in particular pressed together, or twisted or braided together. The metal cable may also comprise a plurality of metal strands, in which a plurality of metal wires are combined into a respective composite, in particular with or without a centrally arranged insert.

In the aforementioned embodiment, the cable section may also comprise a plurality of (for example, two, three, or four) synthetic cables and/or a plurality of (for example, two, three, or four) metal cables. For example, the plurality of securing strands may comprise a single metal cable and two, three, or four synthetic cables as filler material between the chain, the metal cable, and the sheath. This results in a particularly lightweight and yet tamper-resistant structure of the cable section.

According to a further preferred embodiment, at least some, in particular all, of the plurality of securing strands comprise at least a first bundle with fibers made of a first synthetic and at least a second bundle with fibers made of a second synthetic different from the first synthetic, wherein the at least one first bundle and the at least one second bundle are connected to one another, in particular intertwined. The at least one first bundle and the at least one second bundle may, for example, be interwoven or twisted together. The first synthetic and the second synthetic may differ, in particular, in terms of their strength, hardness, and/or heat resistance. As a result, different material properties may be combined in close spatial proximity to one another in order to be able to resist particularly effectively any attack attempt. For example, the first synthetic may exhibit relatively high strength compared to the second synthetic, while the second synthetic exhibits relatively high heat resistance compared to the first synthetic. Thus, the first bundle of the respective securing strand makes it difficult to cut through using a cutting or pinching tool, whereas the second bundle of the respective securing strand makes it difficult to cut through by the effect of heat (in particular, through direct heat exposure or through indirect heat generation due to friction).

The respective (first or second) bundle may be a cohesive, flexible, elongated structure comprising a plurality of synthetic fibers that are braided or twisted together. The at least one first bundle and the at least one second bundle are in turn connected to one another to form the respective securing strand as a joint configuration. Preferably, the respective securing strand comprises a total of more than two bundles, for example three, four, five, six, seven, or eight bundles. In particular, the respective securing strand may comprise at least two first bundles and at least two second bundles. Different ones of the plurality of securing strands may have different numbers of first bundles and/or second bundles.

Gathering together the fibers formed from the first synthetic and the second synthetic into first and second bundles, respectively, and combining the first and second bundles to form a respective securing strand, of which a plurality are provided, has the advantage that the fibers with the different properties are distributed around the circumference of the cable section, so that the respective cutting or attacking tool must be applied at different points in order to ultimately cut through the cable section completely. As a result, any attack is made more difficult and will be time-consuming.

In the aforementioned embodiment, the first synthetic may in particular be a polyethylene-based plastic having a higher tensile strength than the second synthetic, wherein the second synthetic may be a polyamide-based plastic having a higher decomposition temperature than the first synthetic. For example, the first synthetic may be or comprise Dyneema (registered trademark), i.e. a synthetic fiber with a high molecular weight and a typical tensile strength in the range of 3 to 4 GPa (3000 to 4000 N/mm²). The second synthetic may, for example, be or comprise an Aramid, i.e. a synthetic fiber in which amide groups are bound to aromatic groups and which may have a typical decomposition temperature in the range of 370 to 500 degrees Celsius.

In all of the aforementioned embodiments, the sheath of the cable section may be woven from synthetic fibers. The synthetic fibers may, for example, be processed in the form of yarns or twisted yarns. In particular, the sheath may be woven as a hollow fabric around the chain and the plurality of securing strands, whereby, unlike when a prefabricated sheath is slipped over, the plurality of securing strands may be held by the sheath in a tight configuration around the chain, as explained above. The synthetic fibers of the sheath may, for example, consist of polyester, in particular Polyamide. Such a woven sheath may further increase protection against forcibly cutting through the cable section, since an additional layer must be cut through using a suitable attacking tool.

The sheath may be configured, in terms of its density and thickness, to protect the enclosed securing strands from ultraviolet radiation.

The cable section of the securing cable preferably comprises only a single sheath that surrounds the chain and the plurality of securing strands. As a result, a particularly high flexibility of the cable section in the bending direction is supported, and the manufacture of the cable section is cost-effective compared to the applying of multiple sheaths arranged one over the other.

The securing cable described above may form a fully functional bicycle lock. For this purpose, the first securing device provided at the first end of the cable section, as explained in the introduction, may comprise a locking mechanism, wherein the second securing device provided at the second end comprises a counterpart that can be locked to the locking mechanism so as to form and define a circumferentially closed loop (in particular with a fixed circumferential loop length). The locking mechanism may comprise at least one mechanically or electrically actuated latch that interacts with the counterpart when the latter is connected to the locking mechanism. The latch may be movable in a linear or rotational direction.

In other embodiments, the securing cable described above may be designed to interact with an external locking mechanism. For this purpose, the first securing device provided at the first end of the cable section, as explained in the introduction, may comprise an eyelet, wherein the second securing device provided at the second end may be passed through the eyelet so as to form a circumferentially closed loop out of the cable section (in particular with a variable circumferential length of loop). For this, the clearing width of the eyelet must be sufficiently large so that the second securing device is able to pass through it. Moreover, the eyelet may have any shape. In such embodiments, the second securing device may, for example, comprise a further eyelet, which may in particular be configured smaller than the eyelet at the first end, wherein, after threading the additional eyelet through the eyelet located at the first end of the cable section, the additional eyelet may be locked by the use of an external locking mechanism (e.g., a padlock or a stationary lock). Alternatively, the second securing device provided at the second end may, for example, comprise a locking bolt which may generally have any shape and may, for example, be lockable to an associated frame lock of the bicycle or to a stationary lock. According to a further embodiment, the first securing device provided at the first end of the cable section may comprise an eyelet, wherein the second securing device provided at the second end may comprise a locking mechanism which, as explained above, may in particular comprise a movable latch and which, however, is not locked to the first securing device; instead, this locking mechanism may, for example, be lockable at another position of the cable section (with a fixed or variable circumferential length of loop).

The invention also relates to a method for manufacturing a bicycle lock securing cable of the aforementioned type, comprising the following steps:
arranging the chain and the plurality of securing strands side by side in a hanging configuration;
weaving the sheath as a hollow weave around the hanging arrangement of the chain and securing strands so as to form the cable section;
attaching the first securing device to the first end of the cable section; and
attaching the second securing device to the second end of the cable section.

With this method, the securing strands may be held by the sheath in a tight configuration around the chain, as explained above. The hanging arrangement of chain and securing strands may be formed from continuous material respectively, for example by unwinding the chain and the securing strands from spools. In this case, the respective cable section must be disconnected from the continuous material before attaching the first and second securing devices. The first and second securing devices may be attached to the respective end of the cable section, for example, by crimping, riveting, or pinning.

### BRIEF DESCRIPTION OF THE DRAWINGS

The invention is described below merely by way of example with reference to the drawings. Identical or similar elements are designated by the same reference numerals therein.

FIG. 1 shows a securing cable in the form of a bicycle lock.

FIG. 2 shows a cross-section of the securing cable shown in FIG. 1 according to a first embodiment.

FIG. 3 shows a cross-section of the securing cable shown in FIG. 1 according to a second embodiment.

### DETAILED DESCRIPTION

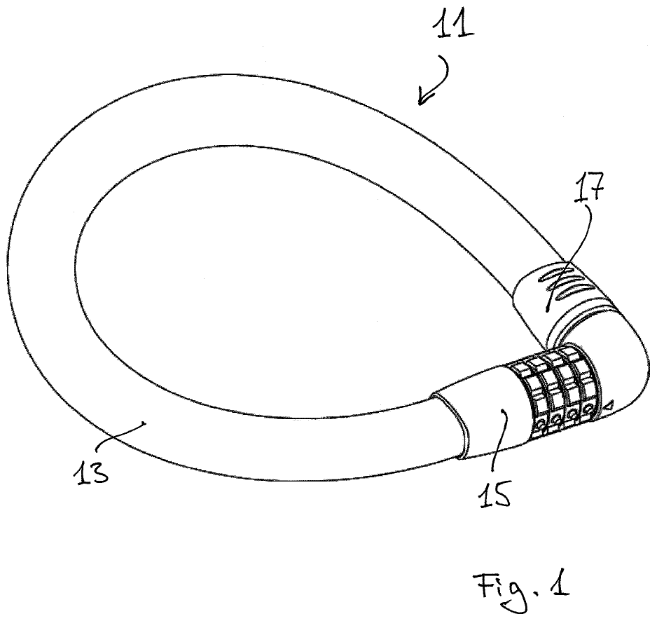

FIG. 1 shows a bicycle lock that is formed by a securing cable 11. The securing cable 11 comprises a flexible cable section 13, a first securing device 15 at a first end of the cable section 13, and a second securing device 17 at a second end of the cable section 13. The bicycle lock serves as a theft protection for a bicycle, for example, in that the bicycle is locked to itself or is secured to a stationary object using the securing cable 11. For this purpose, in the shown embodiment, the first securing device 15 is formed by a lock body with a locking mechanism that comprises a combination lock mechanism, and the second securing device 17 comprises an associated locking bolt. In the shown state of the bicycle lock in FIG. 1, the cable section 13 is formed into a closed loop, and the locking bolt of the second securing device 17 is inserted into the lock body of the first securing device 15 and locked therein. As a result, the loop formed by the cable section 13 is secured in the closed state.

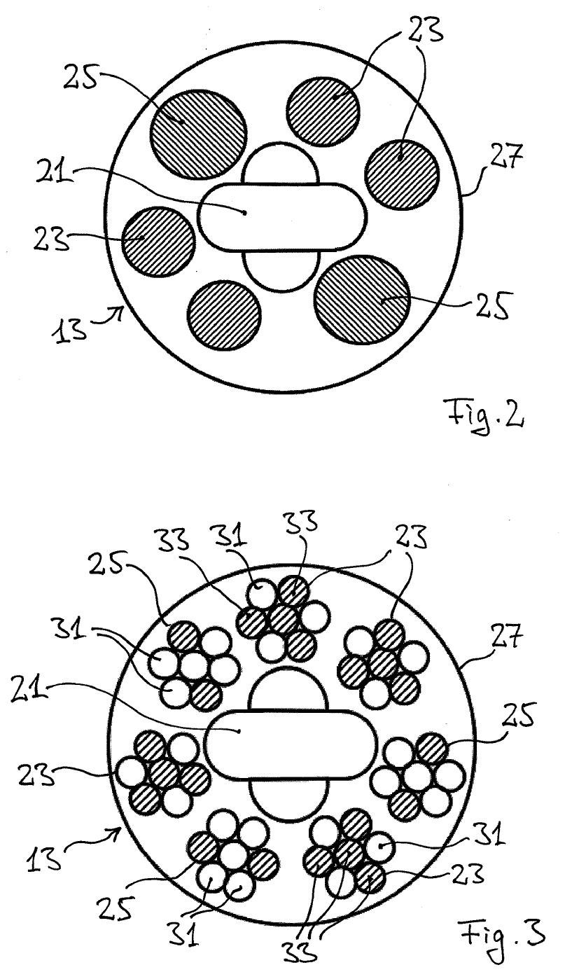

In the following, the structure of the cable section 13 according to two different embodiments is explained with reference to FIGS. 2 and 3.

FIG. 2 shows a schematic cross-section of the cable section 13 shown in FIG. 1 according to a first embodiment.

The cable section 13 comprises a metal chain 21, a plurality of first securing strands 23 distributed along the circumference of the chain 21 and separate from one another, a plurality of second securing strands 25 distributed along the circumference of the chain 21 and separate from one another and from the first securing strands 23; as well as a sheath 27 which circumferentially surrounds the chain 21 and the securing strands 23, 25 and holds them closely together. The chain 21 and the securing strands 23, 25 extend continuously within the sheath 27 between the first securing device 15 and the second securing device 17 and side by side (FIG. 1).

The first securing strands 23 each comprise a synthetic cable, whereas the second securing strands 25 each comprise a metal cable.

FIG. 3 shows a schematic cross-section of the cable section 13 shown in FIG. 1 according to a second embodiment.

The cable section 13 comprises a metal chain 21, a plurality of first securing strands 23 distributed along the circumference of the chain 21 and separate from one another, a plurality of second securing strands 25 distributed along the circumference of the chain 21 and separate from one another and from the first securing strands 23; as well as a sheath 27 that circumferentially surrounds the chain 21 and the securing strands 23, 25 and holds them closely together. The chain 21 and the securing strands 23, 25 extend continuously side by side within the sheath 27 between the first securing device 15 and the second securing device 17 (FIG. 1).

The first and second securing strands 23, 25 each comprise a plurality of first bundles 31 with fibers made of a first synthetic material and a plurality of second bundles 33 with fibers made of a second synthetic material, wherein the first bundles 31 and the second bundles 33 are intertwined with one another so as to form the respective securing strand 23, 25. The first synthetic material may, for example, be a polyethylene-based plastic having a particularly high tensile strength, whereas the second synthetic material may be a polyamide-based plastic having a particularly high decomposition temperature. The first and second securing strands 23, 25 differ in terms of the number of first bundles 31 and second bundles 33.

In the two embodiments shown, the cable section 13 is thus configured as a multi-component body that, in addition to the chain 21, comprises at least two securing strands 23, 25 made of different materials that differ from one another in terms of their strength, hardness, and heat resistance. Therefore, the securing cable 11 offers increased protection against it being forcibly cut through, since the use of a chain 21 in combination with a plurality of other types and materials of securing strands—including at least one non-metal—forms different types of resistance that must be overcome with various types of cutting or attacking tools. As a result, a significant amount of time is required to forcibly cut through the cable section 13, which serves as an effective deterrent for bicycle thieves. Notwithstanding the level of theft protection achieved, the cable section 13 may be configured to be flexible and lightweight, resulting in comfortable handling.

### LIST OF REFERENCE NUMERALS

11 securing cable
13 cable section
15 first securing device
17 second securing device
21 chain
23 first securing strand
25 second securing strand
27 sheath
31 first bundle
33 second bundel

What is claimed is:

1. A bicycle lock securing cable for securing a bicycle, comprising:
a flexible cable section extending from a first end to a second end;
a first securing device at the first end of the cable section; and
a second securing device at the second end of the cable section;
wherein the first securing device and the second securing device are configured to selectively hold the cable section in a closed loop,
wherein the cable section comprises at least:
a metal chain;
a plurality of securing strands distributed along a circumference of the chain and separate from one another; and
a sheath that circumferentially surrounds the chain and the plurality of securing strands;
wherein the securing strands comprise different materials, at least one of which is not metal.

2. A bicycle lock securing cable according to claim 1,
wherein the plurality of securing strands are held by the sheath in a tight configuration around the chain and, however, are supported so as to be movable relative to one another.

3. A bicycle lock securing cable according to claim 1,
wherein at least one of the plurality of securing strands comprises a synthetic cable having a plurality of synthetic fibers, and wherein at least one further of the plurality of securing strands comprises a metal cable having a plurality of metal wires.

4. A bicycle lock securing cable according to claim 1,
wherein one or more of the plurality of securing strands comprises a synthetic cable having a plurality of synthetic fibers, and wherein only a single one of the plurality of securing strands comprises a metal cable having a plurality of metal wires.

5. A bicycle lock securing cable according to claim 3,
wherein the synthetic cable is a cohesive, flexible, elongated structure consisting of a plurality of synthetic fibers that are twisted or braided together, and wherein the metal cable is a cohesive, flexible, elongated structure consisting of a plurality of metal wires that are twisted or braided together.

6. A bicycle lock securing cable according to claim 3,
wherein the synthetic cable is a cohesive, flexible, elongated structure consisting of a plurality of synthetic fibers that are twisted or braided together, and wherein the metal cable comprises a plurality of individual metal strands in which a plurality of metal wires are combined into a respective composite with or without a centrally arranged insert.

7. A bicycle lock securing cable according claim 3,
wherein the cable section of the securing cable comprises only a single sheath that surrounds the chain and the plurality of securing strands.

8. A bicycle lock securing cable according to claim 1,
wherein at least some of the plurality of securing strands comprise at least a first bundle with fibers made of a first synthetic and at least a second bundle with fibers made of a second synthetic different from the first synthetic, wherein the at least one first bundle and the at least one second bundle are connected with one another.

9. A bicycle lock securing cable according to claim 8,
wherein the at least one first bundle and the at least one second bundle are intertwined.

10. A bicycle lock securing cable according to claim 8,
wherein different ones of the plurality of securing strands comprise different numbers of first bundles and/or second bundles.

11. A bicycle lock securing cable according to claim 8,
wherein the first synthetic is a polyethylene-based plastic having a higher tensile strength than the second synthetic, and wherein the second synthetic is a polyamide-based plastic having a higher decomposition temperature than the first synthetic.

12. A bicycle lock securing cable according to claim 8,
wherein the cable section of the securing cable comprises only a single sheath that surrounds the chain and the plurality of securing strands.

13. A bicycle lock securing cable according to claim 1,
wherein the sheath is woven from synthetic fibers.

14. A bicycle lock securing cable according to claim 1,
wherein the first securing device comprises a locking mechanism and the second securing device comprises a counterpart that can be locked to the locking mechanism to form the closed loop.

15. A bicycle lock securing cable according to claim 1,
wherein the first securing device comprises an eyelet, wherein the second securing device may be passed through the eyelet to form the closed loop.

16. A bicycle lock securing cable for securing a bicycle, comprising:
a flexible cable section extending from a first end to a second end;
a first securing device at the first end of the cable section; and
a second securing device at the second end of the cable section;
wherein the first securing device and the second securing device are configured to selectively hold the cable section in a closed loop,
wherein the cable section comprises at least:
a metal chain;
a plurality of securing strands distributed along a circumference of the chain and separate from one another; and
a single sheath that circumferentially surrounds the chain and the plurality of securing strands;
wherein one or more of the plurality of securing strands comprises a synthetic cable that is a flexible, elongated structure comprising a plurality of synthetic fibers twisted or braided together, and
wherein only a single one of the plurality of securing strands comprises a metal cable that is a flexible, elongated structure comprising a plurality of metal wires twisted or braided together.

17. A method for manufacturing a bicycle lock securing cable, comprising the following steps:
arranging a metal chain and a plurality of separate securing strands side by side in a hanging configuration, wherein the plurality of securing strands are distributed along a circumference of the chain and comprise different materials, at least one of which is not metal, and wherein the hanging arrangement of the metal chain and the plurality of securing strands is formed from continuous material respectively;
weaving a sheath as a hollow weave around the hanging arrangement of the metal chain and the plurality of securing strands;
disconnecting a cable section from the arrangement of the metal chain, the plurality of securing strands and the sheath such that the cable section extends from a first end to a second end;
attaching a first securing device to the first end of the cable section; and
attaching a second securing device to the second end of the cable section.
